(19) United States
(12) Patent Application Publication
(10) Pub. No.: US 2025/0131319 A1
(43) Pub. Date: Apr. 24, 2025

(54) METHODS AND SYSTEMS FOR DETERMINING ATTRIBUTES AND/OR INFORMATION ABOUT A LOCATION USING A MACHINE LEARNING MODEL PERFORMING PATTERN ANALYSIS

(71) Applicant: Capital One Services, LLC, McLean, VA (US)

(72) Inventors: Owen Reinert, Queens, NY (US); Jeremy Goodsitt, Champaign, IL (US); Taylor Turner, Richmond, VA (US); Justin Au-Yeung, Somerville, MA (US)

(21) Appl. No.: 18/383,178

(22) Filed: Oct. 24, 2023

(51) Int. Cl. G06N 20/00

(52) U.S. Cl. CPC G06N 20/00

(57) ABSTRACT

The present disclosure describes training machine learning models to determine one or more attributes and/or information associated with a location. The one or more attributes and/or information may be based on location traffic and/or connectivity information. After the machine learning model is trained and deployed, the machine learning model may determine one or more attributes and/or information about a location based on received location traffic and/or connectivity information. The machine learning model may receive a plurality of connectivity information associated with a location. Each of the plurality of connectivity information may correspond to a respective user device. Based on the connectivity information, the machine learning model may determine one or more attributes and/or information associated with the location. The one or more attributes and/or information may be provided to a user device in response to inquiries about the location.

### FIELD OF THE INVENTION

Aspects of the disclosure generally relate to training machine learning models to perform pattern analysis and using the machine learning model to determine information and/or attributes based on the pattern analysis.

### BACKGROUND OF THE INVENTION

Businesses may provide information about themselves, such as operating hours and maps, via their websites. Moreover, information aggregators, such as Google and Apple, may collect business information and display the business information in response to searches for a particular business. However, the information provided by both the businesses and information aggregators may be incorrect and/or out-of-date. In this regard, the information is only as accurate as the information provided by users. Moreover, the computer systems of the businesses and/or the information aggregators are unable to ascertain accurate information associated with the business. This is further compounded when the information (e.g., operating hours) may change, for example, due to holidays or inclement weather. Similarly, the information (e.g., maps) may be outdated, for example, due to remodeling. Accordingly, there is a need in the art for businesses and/or information aggregators to collect information and provide accurate information when requested via a search.

### SUMMARY OF THE INVENTION

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may relate to training machine learning models to determine one or more attributes and/or information associated with a location based on location traffic and/or connectivity information. After the machine learning model is trained and deployed, the machine learning model may determine one or more attributes and/or information about a location based on received location traffic and/or connectivity information.

Further aspects of the present disclosure describe a computer-implemented method that receives a first location of a user device connected to a network associated with a commercial establishment. The first location may comprise a first timestamp. Additionally, the first location may be determined based on a first distance the user device is from at least a first access point of the mesh network. The computer-implemented method may receive a second location of the first user device connected to the mesh network associated with the commercial establishment. The second location may comprise a second timestamp. Further the second location may be determined based on a second distance the user device is from at least a second access point that is different from the first access point. The computer-implemented may generate, based on pattern analysis using a machine learning algorithm, a mapping of the commercial establishment. The mapping may indicate one or more areas of the commercial establishment. The computer-implemented method may also compare the first timestamp and the second timestamp to publicly available information associated with the commercial establishment. The computer-implemented method may determine, based on a comparison of the first timestamp and the second timestamp to publicly available operating hours for the commercial establishment, actual operating hours of the commercial establishment. The computer-implemented method may provide, based on a request for information associated with the commercial establishment, a response indicating the mapping and the actual operating hours.

Additional aspects of the disclosure describe a computer-implemented method that receives a first indication of a first user device connected to a mesh network associated with a commercial establishment. The indication may comprise a first timestamp and a first location of the first user device that is determined based on a first distance the first user device is from at least a first access point of the mesh network. The computer-implemented method may receive a second indication of a second user device connected to the mesh network associated with the commercial establishment. The second indication may comprise a second timestamp and a second location of the second user device that is determined based on a second distance the second user device is from at least the first access point of the mesh network. The computer-implemented method may generate, based on pattern analysis of at least the first user device and the second user device and using a machine learning algorithm, a mapping of the commercial establishment that indicates one or more areas of the commercial establishment. The computer-implemented method may provide, based on a request for information associated with the commercial establishment, a response indicating the mapping.

Further aspects of the disclosure describe a computer-implemented method that receives a first indication of a first user device connected to a mesh network associated with a commercial establishment. The first indication may comprise a first timestamp. The computer-implemented method may receive a second indication of a second user device connected to the mesh network associated with the commercial establishment. The second indication may comprise a second timestamp, different from the first timestamp. The computer-implemented method may determine, based on pattern analysis using a machine learning algorithm and based on the first timestamp and based on the second timestamp, a plurality of times during which user devices connect to the mesh network. The computer-implemented method may compare the plurality of times during which user devices connect to the mesh network to publicly available information associated with the commercial establishment. The computer-implemented method may determine, based on a comparison of the plurality of times during which user devices connect to the mesh network to the publicly available operating hours for the commercial establishment, actual operating hours of the commercial establishment. The computer-implemented method may provide, based on a request for information associated with the commercial establishment, a response indicating the actual operating hours.

These features, along with many others, are discussed in greater detail below.

### BRIEF DESCRIPTION OF DRAWINGS

The present disclosure is illustrated by way of example and not limited in the accompanying figures in which like reference numerals indicate similar elements and in which:

FIG. 1 shows an example of a system in which one or more features described herein may be implemented;

FIG. 2 shows an example computing device in accordance with one or more aspects of the disclosure;

FIG. 3 shows a flow chart of a process for obtaining information associated with a location according to one or more aspects of the disclosure;

FIGS. 4A-4C show an example of gathering information associated with a location in accordance with one or more aspects of the disclosure; and

FIGS. 5A-5B show an example of displaying information associated with a location in accordance with one or more aspects of the disclosure.

### DETAILED DESCRIPTION OF THE INVENTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects described herein may relate to training machine learning models to determine one or more attributes and/or information associated with a location based on location traffic and/or connectivity information. The machine learning models may be trained, for example, using historical connectivity information. The historical connectivity information may comprise information about user devices connecting to one or more access points associated with a location. For example, the historical connectivity information may indicate an order in which user devices connect to each of the access points or a signal strength between a user device and one or more access points. The historical connectivity information may also comprise a duration of how long each user device was connected to each access point. The machine learning models may be trained to identify patterns from the historical connectivity information and determine one or more attributes about a location.

Additional aspects described herein may relate to using the trained machine learning model to learn one or more attributes (e.g., operating hours, a map of the location, etc.) of a location. Computing systems suffer from a technical problem of being unable to obtain information about a location on their own. Rather, computing systems can only use the information that is inputted by one or more users. The present disclosure provides a solution to that problem by allowing computing systems to determine attributes and/or information about a location based on location traffic and/or connectivity information of devices connected to a network associated with a location. In order to arrive at the solution, a computing device may receive first connectivity information associated with a user device connected to a network associated with the location. The computing device may also receive second connectivity information of the user device connected to the network. The computing device may determine one or more attributes of the location using the machine learning model. In this regard, the machine learning model may perform a pattern analysis using at least the first connectivity information and the second connectivity information. The one or more attributes determined by the machine learning model may be compared to publicly available information. For example, the one or more attributes may comprise actual operating hours (e.g., when the store is actually opened), which may be compared to the posted operating hours. This improves the system's ability to determine operating hours, for example, during holidays. When there are differences between the one or more attributes and the publicly available information, one or more remedial actions may be taken to correct the discrepancy. By using the location traffic and/or connectivity information of devices connected to a network, the computing devices are better able to determine information associated with a location. This improves over prior techniques, which require a user to manually enter information. This may cause the information to become stale and/or out-of-date. The techniques described herein allow a computer to automatically determine information about a location based on location traffic and/or connectivity information of devices connected to a network associated with the location. This improves the system's ability to provide up-to-date information associated with various location without requiring a user to input the information.

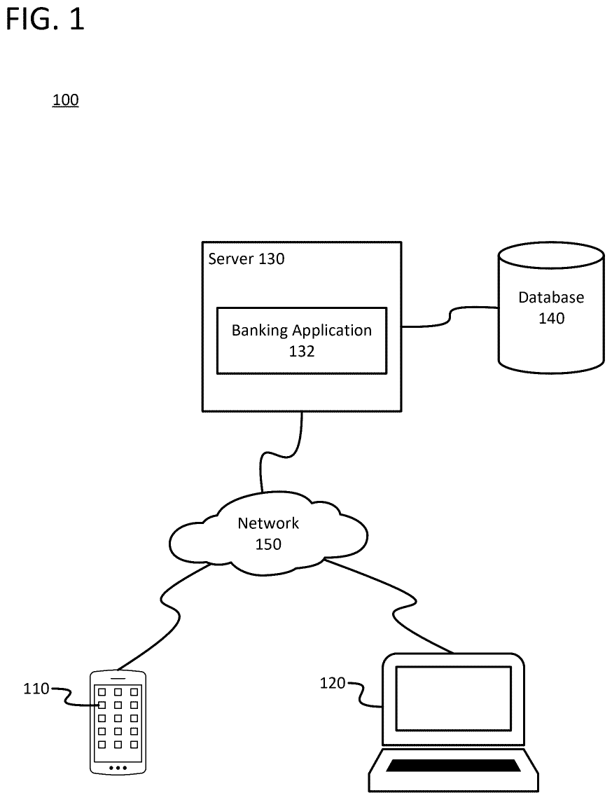

FIG. 1 shows an example of a system 100 that includes a first user device 110, a second user device 120, and a server 130, connected to a database 140, interconnected via network 150.

First user device 110 may be a mobile device, such as a cellular phone, a mobile phone, a smart phone, a tablet, a laptop, or an equivalent thereof. First user device 110 may provide a first user with access to various applications and services. For example, first user device 110 may provide the first user with access to the Internet. Additionally, first user device 110 may provide the first user with one or more applications (“apps”) located thereon. The one or more applications may provide the first user with a plurality of tools and access to a variety of services. In some embodiments, the one or more applications may include a banking application that provides access to the first user's banking information, as well as perform routine banking functions, such as checking the first user's balance, paying bills, transferring money between accounts, withdrawing money from an automated teller machine (ATM), and wire transfers. The banking application may comprise an authentication process to verify (e.g., authenticate) the identity of the first user prior to granting access to the banking information.

Second user device 120 may be a computing device configured to allow a user to execute software for a variety of purposes. Second user device 120 may belong to the first user that accesses first user device 110, or, alternatively, second user device 120 may belong to a second user, different from the first user. Second user device 120 may be a desktop computer, laptop computer, or, alternatively, a virtual computer. The software of second user device 120 may include one or more web browsers that provide access to websites on the Internet. These websites may include banking websites that allow the user to access his/her banking information and perform routine banking functions. In some embodiments, second user device 120 may include a banking application that allows the user to access his/her banking information and perform routine banking functions. The banking website and/or the banking application may comprise an authentication component to verify (e.g., authenticate) the identity of the second user prior to granting access to the banking information.

Server 130 may be any server capable of executing banking application 132. Additionally, server 130 may be communicatively coupled to database 140. In this regard, server 130 may be a stand-alone server, a corporate server, or a server located in a server farm or cloud-computer environment. According to some examples, server 130 may be a virtual server hosted on hardware capable of supporting a plurality of virtual servers.

Banking application 132 may be server-based software configured to provide users with access to their account information and perform routing banking functions. In some embodiments, banking application 132 may be the server-based software that corresponds to the client-based software executing on first user device 110 and second user device 120. Additionally, or alternatively, banking application 132 may provide users access to their account information through a website accessed by first user device 110 or second user device 120 via network 150. The banking application 132 may comprise an authentication module to verify users before granting access to their banking information. Additionally or alternatively, banking application 132 may comprise an automated customer service solution, such as a chatbot or an automated answering service.

Database 140 may be configured to store information on behalf of application 132. The information may include, but is not limited to, personal information, account information, and user-preferences. Personal information may include a user's name, address, phone number (i.e., mobile number, home number, business number, etc.), social security number, username, password, employment information, family information, and any other information that may be used to identify the first user. Account information may include account balances, bill pay information, direct deposit information, wire transfer information, statements, and the like. User-preferences may define how users receive notifications and alerts, spending notifications, and the like. Additionally or alternatively, database 140 may store a plurality of multi-party dialogues, including, for examples, recorded conversations between a customer and a service agent, transcribed conversations, interactions between a customer and a chatbot, etc. Database 140 may include, but are not limited to relational databases, hierarchical databases, distributed databases, in-memory databases, flat file databases, XML databases, NoSQL databases, graph databases, and/or a combination thereof.

Network 150 may include any type of network. In this regard, network 150 may include the Internet, a local area network (LAN), a wide area network (WAN), a wireless telecommunications network, and/or any other communication network or combination thereof. It will be appreciated that the network connections shown are illustrative and any means of establishing a communications link between the computers may be used. The existence of any of various network protocols such as TCP/IP, Ethernet, FTP, HTTP and the like, and of various wireless communication technologies such as GSM, CDMA, WiFi, and LTE, is presumed, and the various computing devices described herein may be configured to communicate using any of these network protocols or technologies. The data transferred to and from various computing devices in system 100 may include secure and sensitive data, such as confidential documents, customer personally identifiable information, and account data. Therefore, it may be desirable to protect transmissions of such data using secure network protocols and encryption, and/or to protect the integrity of the data when stored on the various computing devices. For example, a file-based integration scheme or a service-based integration scheme may be utilized for transmitting data between the various computing devices. Data may be transmitted using various network communication protocols. Secure data transmission protocols and/or encryption may be used in file transfers to protect the integrity of the data, for example, File Transfer Protocol (FTP), Secure File Transfer Protocol (SFTP), and/or Pretty Good Privacy (PGP) encryption. In many embodiments, one or more web services may be implemented within the various computing devices. Web services may be accessed by authorized external devices and users to support input, extraction, and manipulation of data between the various computing devices in the system 100. Web services built to support a personalized display system may be cross-domain and/or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. For example, secure network appliances may include built-in features such as hardware-accelerated SSL and HTTPS, WS-Security, and/or firewalls. Such specialized hardware may be installed and configured in system 100 in front of one or more computing devices such that any external devices may communicate directly with the specialized hardware.

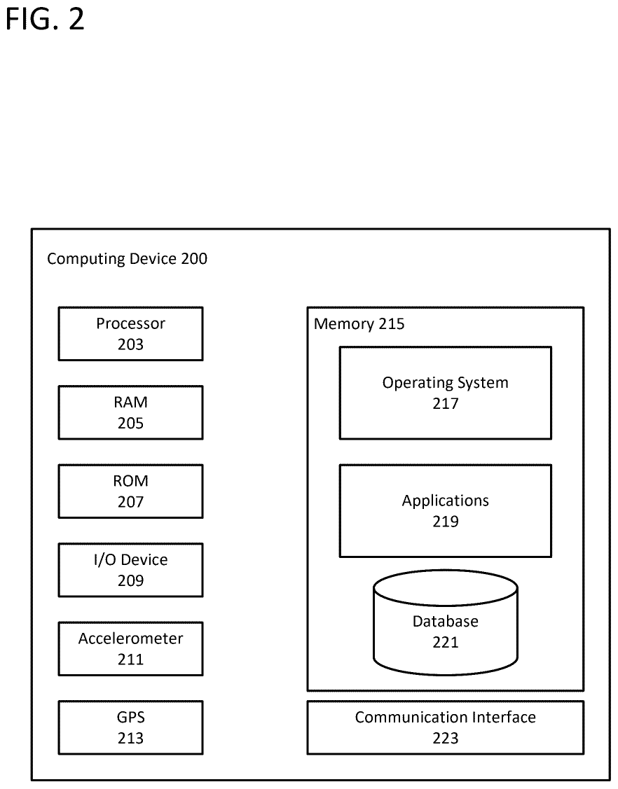

Any of the devices and systems described herein may be implemented, in whole or in part, using one or more computing devices described with respect to FIG. 2. Turning now to FIG. 2, a computing device 200 that may be used with one or more of the computational systems is described. The computing device 200 may comprise a processor 203 for controlling overall operation of the computing device 200 and its associated components, including RAM 205, ROM 207, input/output device 209, accelerometer 211, global-position system antenna 213, memory 215, and/or communication interface 223. A bus 202 may interconnect processor(s) 203, RAM 205, ROM 207, memory 215, I/O device 209, accelerometer 211, global-position system receiver/antenna 213, memory 215, and/or communication interface 223. Computing device 200 may represent, be incorporated in, and/or comprise various devices such as a desktop computer, a computer server, a gateway, a mobile device, such as a laptop computer, a tablet computer, a smart phone, any other types of mobile computing devices, and the like, and/or any other type of data processing device.

Input/output (I/O) device 209 may comprise a microphone, keypad, touch screen, and/or stylus through which a user of the computing device 200 may provide input, and may also comprise one or more speakers for providing audio output and a video display device for providing textual, audiovisual, and/or graphical output. Software may be stored within memory 215 to provide instructions to processor 203 allowing computing device 200 to perform various actions. For example, memory 215 may store software used by the computing device 200, such as an operating system 217, application programs 219, and/or an associated internal database 221. The various hardware memory units in memory 215 may comprise volatile and nonvolatile, removable and non-removable media implemented in any method or technology for storage of information such as computer-readable instructions, data structures, program modules, or other data. Memory 215 may comprise one or more physical persistent memory devices and/or one or more non-persistent memory devices. Memory 215 may comprise random access memory (RAM) 205, read only memory (ROM) 207, electronically erasable programmable read only memory (EEPROM), flash memory or other memory technology, optical disk storage, magnetic cassettes, magnetic tape, magnetic disk storage or other magnetic storage devices, or any other medium that may be used to store the desired information and that may be accessed by processor 203.

Accelerometer 211 may be a sensor configured to measure accelerating forces of computing device 200. Accelerometer 211 may be an electromechanical device. Accelerometer may be used to measure the tilting motion and/or orientation computing device 200, movement of computing device 200, and/or vibrations of computing device 200. The acceleration forces may be transmitted to the processor to process the acceleration forces and determine the state of computing device 200.

GPS receiver/antenna 213 may be configured to receive one or more signals from one or more global positioning satellites to determine a geographic location of computing device 200. The geographic location provided by GPS receiver/antenna 213 may be used for navigation, tracking, and positioning applications. In this regard, the geographic may also include places and routes frequented by the first user.

Communication interface 223 may comprise one or more transceivers, digital signal processors, and/or additional circuitry and software, protocol stack, and/or network stack for communicating via any network, wired or wireless, using any protocol as described herein.

Processor 203 may comprise a single central processing unit (CPU), which may be a single-core or multi-core processor, or may comprise multiple CPUs. Processor(s) 203 and associated components may allow the computing device 200 to execute a series of computer-readable instructions (e.g., instructions stored in RAM 205, ROM 207, memory 215, and/or other memory of computing device 215, and/or in other memory) to perform some or all of the processes described herein. Although not shown in FIG. 2, various elements within memory 215 or other components in computing device 200, may comprise one or more caches, for example, CPU caches used by the processor 203, page caches used by the operating system 217, disk caches of a hard drive, and/or database caches used to cache content from database 221. A CPU cache may be used by one or more processors 203 to reduce memory latency and access time. A processor 203 may retrieve data from or write data to the CPU cache rather than reading/writing to memory 215, which may improve the speed of these operations. In some examples, a database cache may be created in which certain data from a database 221 is cached in a separate smaller database in a memory separate from the database, such as in RAM 205 or on a separate computing device. For example, in a multi-tiered application, a database cache on an application server may reduce data retrieval and data manipulation time by not needing to communicate over a network with a back-end database server. These types of caches and others may provide potential advantages in certain implementations of devices, systems, and methods described herein, such as faster response times and less dependence on network conditions when transmitting and receiving data.

Although various components of computing device 200 are described separately, functionality of the various components may be combined and/or performed by a single component and/or multiple computing devices in communication without departing from the disclosure.

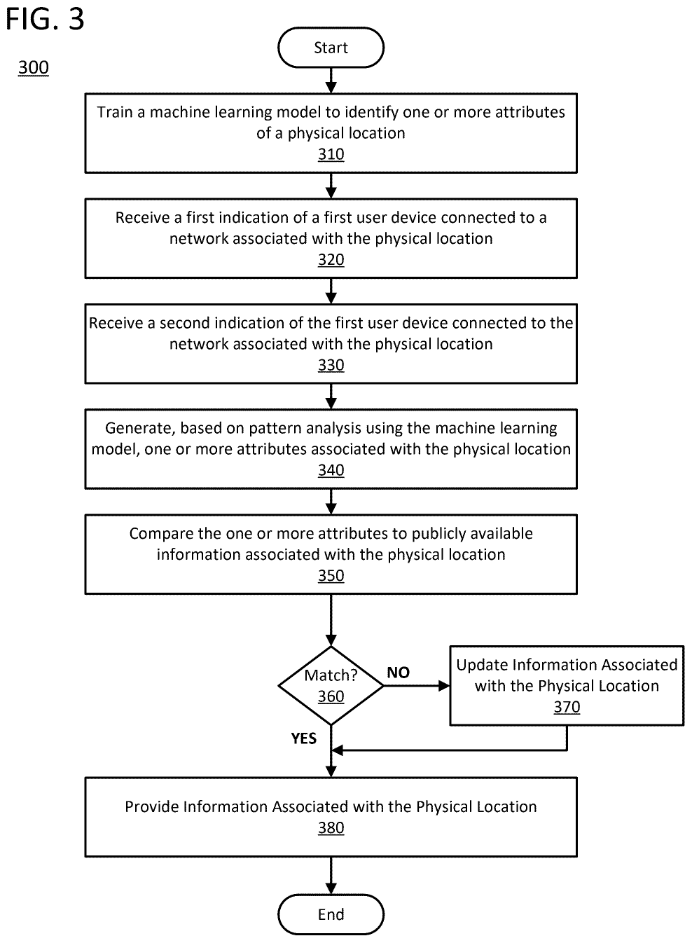

FIG. 3 shows a flow chart of a process for obtaining information associated with a location according to one or more aspects of the disclosure. Some or all of the steps of process 300 may be performed using one or more computing devices as described herein, including, for example, the first user device 110, the second user device 120, the server 130, the computing device 200, or any combination thereof.

In step 310, a computing device may train one or more machine learning models to determine (e.g., identify) one or more attributes of a physical location. As will be discussed in greater detail below, the one or more attributes of the physical location may be determined, for example, based on location data of one or more user devices within the location. Additionally or alternatively, the one or more attributes may be determined, for example, based on publicly available information, such as operating hours, locations, maps of the location, etc. Preferably, the one or more machine learning models are transformer-based models (e.g., sequence-to-sequence (Seq2Seq), etc.) or an equivalent thereof. Additionally or alternatively, the one or more machine learning models may be a neural network, such as a convolutional neural network (CNN), a recurrent neural network, a recursive neural network, a long short-term memory (LSTM), a gated recurrent unit (GRU), an unsupervised pre-trained network, a space invariant artificial neural network, a generative adversarial network (GAN), or a consistent adversarial network (CAN), such as a cyclic generative adversarial network (C-GAN), a deep convolutional GAN (DC-GAN), GAN interpolation (GAN-INT), GAN-CLS, a cyclic-CAN (e.g., C-CAN), or any equivalent thereof. Additionally or alternatively, the one or more machine learning models may comprise one or more decision trees. In some instances, the one or more machine learning models may comprise a Hidden Markov Model. The one or more machine learning models may be trained using supervised learning, unsupervised learning, back propagation, transfer learning, Adam stochastic optimization, stochastic gradient descent, learning rate decay, dropout, max pooling, batch normalization, long short-term memory, skip-gram, or any equivalent deep learning technique. The one or more machine learning models may be trained using self-supervised learning (e.g., contrastive learning) to decouple the embedding spaces of the negative and positive examples. The one or more machine learning models may be trained, for example, using historical connectivity information. In this regard, the location may comprise a network with one or more access points. In some examples, the network is a mesh network. The mesh network may be associated with a commercial establishment or a point-of-interest, such as a museum. The historical connectivity information may comprise one or more locations of access points. Additionally or alternatively, the historical connectivity information may comprise information about user devices connecting to each of the access points. For example, the historical connectivity information may indicate an order in which user devices connect to each of the access points. The historical connectivity information may also include a signal strength between a user device and one or more access points to indicate (e.g., triangulate) a location of the user device within the commercial establishment or the point-of-interest. The historical connectivity information may also comprise a duration of how long each user device was connected to each access point. The corpus of historical connectivity information may be divided into training data and testing data. Preferably, 65% to 85% of the corpus would form the training data, while the remaining 15% to 35% of the corpus would be test data. The one or more machine learning models may be trained using the training data, while the test data would be used to help the machine learning model achieve convergence (i.e., an error range with an acceptable tolerance). The one or more machine learning models may be trained to identify patterns from the historical connectivity information. That is, the one or more machine learning models may perform pattern analysis on the connectivity information to determine one or more attributes about a location. Once the one or more machine learning models are trained to determine one or more attributes about a location, the one or more machine learning models may be deployed, for example, on one or more servers.

In step 320, the computing device may receive first connectivity information of a user device connected to a network. The computing device may comprise one or more servers, such as a back-end server, on which the one or more machine learning models are deployed. The one or more servers may receive first connectivity information from one or more applications executing on the user device. Additionally or alternatively, the one or more servers may receive first connectivity information from the network. That is, the network may provide connectivity information of one or more user devices to the back-end server. In some instances, the network may provide connectivity information of the one or more user devices over a period of time. The connectivity information may comprise a first location of a user device within the location. The first location may be determined based on the user device being connected to a network, such as a mesh network, associated with the location. The mesh network may comprise a plurality of Internet-of-Things (IoT) devices, such as a point-of-sale terminal, a security device, a security camera, a thermostat, a kiosk, a lighting controller, vending machines, digital signage, monitoring systems, an employee device, or the like. The first location may be determined, for example, based on a first distance the user device is from at least a first access point of the network. The first distance may be determined, for example, using a round trip time and/or a signal strength between the user device and the first access point. In some examples, the first connectivity information may be determined, for example, based on how far the user device is from a plurality of access points. That is, the location may be triangulated based on the distances between the user device and each respective access point of the plurality of access points. In some instances, the first connectivity information may also comprise a first timestamp. The first connectivity information may comprise a first indication that the user device is connected to the network associated with the location. In some instance, the first connectivity information may include an identifier (e.g., SSID, network identifier, etc.) that identifies the location.

In step 330, the computing device may receive second connectivity information of the user device. The second connectivity information may comprise a second location of the user device at the location. The second location may be determined, for example, based on the user device being connected to the network. The second location may be determined, for example, based on a second distance the user device is from at least a second access point that is different from the first access point. The second connectivity information may also comprise a second timestamp. It will be appreciated that the second connectivity information may include the same, or substantially the same, information as the first connectivity information, discussed above. While FIG. 3 shows first and second connectivity information, it will be appreciated that additional connectivity information may be used to determine one or more attributes associated with a location.

In step 340, the computing device may generate one or more attributes about a location, for example, based on the first connectivity information and the second connectivity information. For example, the computing device may use the one or more machine learning models to identify the one or more attributes. The one or more attributes may be generated, for example, based on pattern analysis of the first connectivity information and the second connectivity information. The one or more attributes may comprise a map of the location. The map may indicate one or more areas of a commercial establishment, such as an entrance, a fitting room, a point-of-sale terminal, an office, etc. In some instances, the computing device may generate a real-time location of one or more user devices. The real-time location of the one or more user devices may be useful in determining whether a user associated with a device needs assistance. In this regard, a user device may remain in a single location for an extended period of time. Remaining in a single location for an extended period of time may indicate that a customer is considering purchasing an item and needs assistance from a sales representative. Alternatively, remaining in a single location for an extended period of time may indicate that a customer needs medical assistance. In either scenario, an employee may be notified. The notification may be an electronic communication, such as a push notification, a text message, an email alert, a pop-up on a terminal (e.g., a point-of-sale terminal), and the like. The one or more machine learning models may be able to identify peak times (e.g., busy) associated with the location. In some instances, the one or more machine learning models may be able to determine whether the actual operating hours match posted operating hours, for example, based on the pattern analysis. In further examples, the one or more machine learning models may identify user devices that are associated with employees and/or managers, for example, based on a frequency with which a device connects to the network. A determination of the actual operating hours may be based on a presence or absence of the device associated with the employee. In still further examples, the one or more machine learning models may provide suggestions for improving a layout of the location, for example, by determining a location for a kiosk.

In step 350, the computing device may compare the one or more determined attributes to publicly available information associated with the location. As noted above, the one or more determined attributes may comprise actual operating hours of a commercial establishment, which may be determined based on at least timestamp information received with the connectivity information. The actual operating hours may be compared to publicly available information about the posted operating hours. In further examples, the one or more attributes may comprise a map of the location. The map may be compared to a publicly available map. The publicly available information may be obtained, for example, from a website using a scraping algorithm. In some instances, the connectivity information may include an identifier (e.g., SSID, network identifier, etc.) that identifies the location. The publicly available information may be retrieved, for example, using the identifier. Additionally or alternatively, the publicly available information may be received directly from the location. That is, the location may provide the publicly available information directly to the back-end servers via one or more electronic communications.

In step 360, the computing device may determine whether the one or more determined attributes match the publicly available information. For example, the computing device may determine whether the actual operating hours match the posted operating hours. In another example, the computing device may determine whether a map of the location matches a publicly available map of the location. If the one or more determined attributes do not match the publicly available information, the process may proceed to step 370. In some instance, the computing device may determine whether the one or more determined attributes match the previously recorded information about the location. That is, the computing device may generate an alert and/or determine that the determined attributes do not match previously stored information, for example, if the one or more determined attributes (e.g., an actual sequence of device location, sequence of location data, etc.) is significantly different from a predicted sequence of events.

In step 370, the computing device may update information associated with the location, for example, based on a determination that the one or more determined attributes do not match publicly available information. In some examples, the computing device may update information associated with the location in a database. The attributes and/or information in the database may be provided to one or more customers and/or users, for example, in response to one or more search queries for the location. Additionally or alternatively, the computing device may modify information of the location, for example, via one or more user interfaces. In some instances, the information of the location may be provided, for example, in response to detecting a user device approaching and/or near the location. The information may be provided via one or more electronic communications, such as a push notification via one or more mobile applications, a text message, an email alert, and the like.

In step 380, the computing device may receive a request for information associated with the location. The computing device may provide a response indicating the information, for example, in response to receiving the request for information. As noted above, the information may comprise at least one of a mapping of the location, operating hours of the location, or peak times of the location. As noted above, the information may be provided, for example, in response to detecting a user device approaching and/or near the location. The computing device may receive a physical location of the user device from the GPS/receiver antenna 213 of the user device. Based on the physical location of the user device, the computing device may determine that the user is at the location. The computing device may provide the information associated with the location, for example, based on a determination that the user is at the location. The information may be provided via one or more electronic communications, such as a push notification via one or more mobile applications, a text message, an email alert, and the like.

By using the techniques described above, the system is able to collect information and provide accurate information when requested via a search. As noted above, information provided by websites and/or information aggregators is only as good as the information provided by users. That is, the computing devices are unable to obtain information about the location on their own. Using the techniques discussed herein, computing devices are able to ascertain location information based on location traffic and/or device connectivity. The techniques herein improve a computing device's ability to obtain information about a location using crowdsourcing, location traffic, and/or connectivity information.

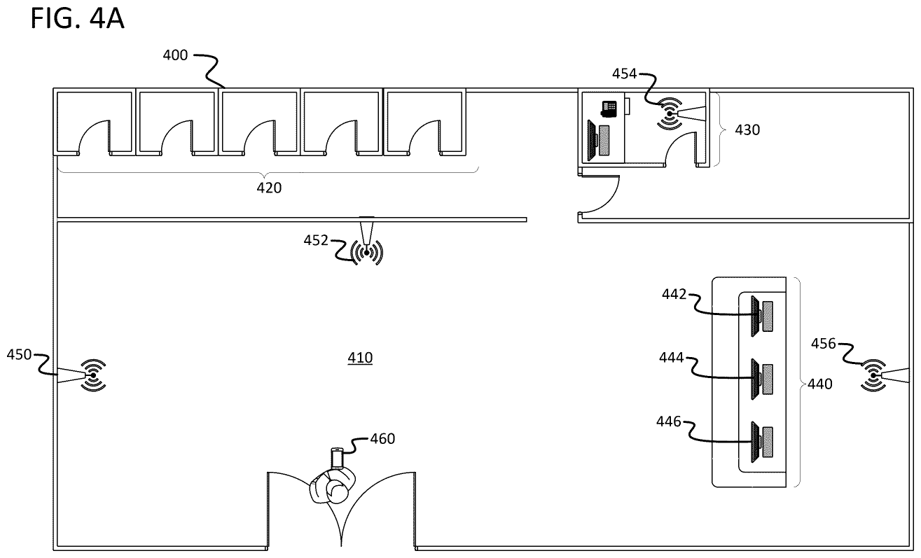

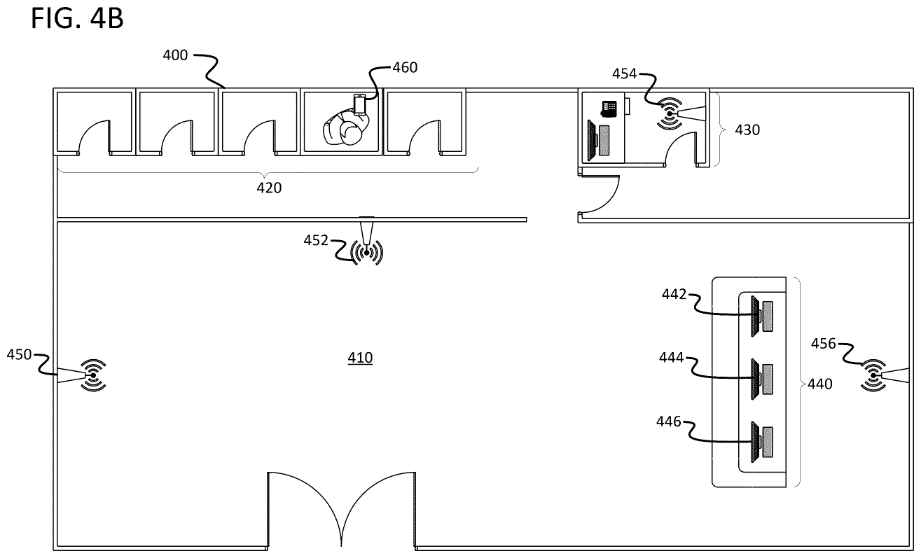

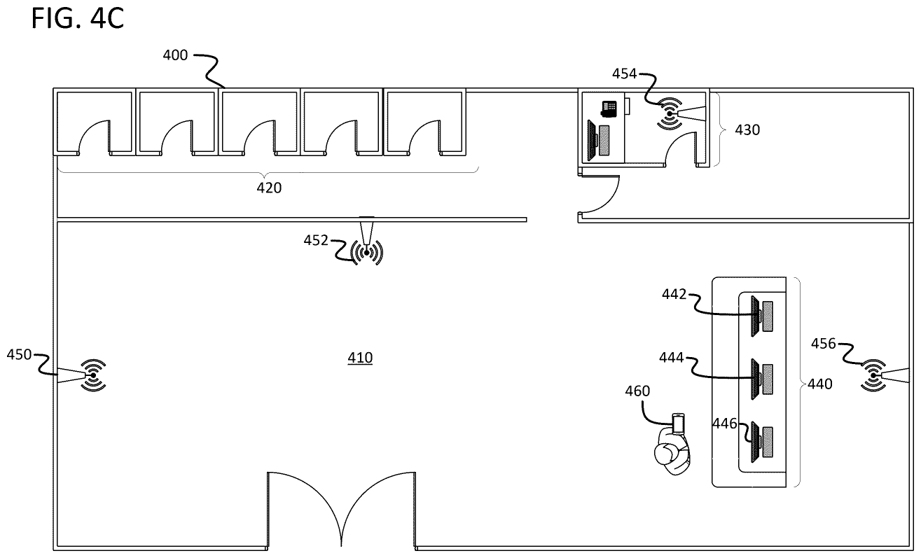

As noted above, the machine learning model may be trained identify information based on pattern analysis of device connectivity to one or more access points in a network. FIGS. 4A-4C show an example of gathering information associated with a location in accordance with one or more aspects of the disclosure. Some or all of the information gathering illustrated in FIGS. 4A-4C may be performed using one or more computing devices as described herein, including, for example, the first user device 110, the second user device 120, the server 130, the computing device 200, or any combination thereof.

FIGS. 4A-4C show an example of location 400. As shown in FIGS. 4A-4C, location 400 may comprise a commercial location, such as a store. While location 400 is shown as a commercial location in FIGS. 4A-4C, it will be appreciated that location 400 may be any suitable location, including, for example, a public location, such as a park or monument. Location 400 comprises a general area 410, a fitting area 420, an office 430, and a check-out area 440. Check-out area 440 may comprise first point-of-sale terminal 442, second point-of-sale terminal 444, and third point-of-sale terminal 446. Additionally location 400 may comprise a plurality of access points, including, for example, first access point 450, second access point 452, third access point 454, and fourth access point 456. While four access points are shown in FIGS. 4A-4C, it will be appreciated that more, or fewer, access points may be used in a location. As noted above, the plurality of access points may form a network associated with location 400. Preferably the network comprises a mesh network. Although not shown in FIGS. 4A-4C, it will be appreciated that other devices, such as security devices, security cameras, thermostats, kiosks, lighting controllers, vending machines, digital signage, monitoring systems, and the like, may form, or be part of, the mesh network.

As shown in FIG. 4A, a user, carrying user device 460, may enter location 400 at a first time. Upon entering location 400, user device 460 may connect to the network. In particular, user device 460 may connect to one or more access points. As noted above, user device 460 may connect to two or more access points (e.g., first access point 450, second access point 452). Connectivity information from the two access points may be used to determine a first location of user device 460. For example, the first location of user device 460 may be determined, for example, based on a first roundtrip time between the first access point 450 and the user device 460 and a second roundtrip time between the second access point 452 and the user device 460. Additionally or alternatively, the first location of user device 460 may be determined, for example, based on a first signal strength between the first access point 450 and the user device 460 and a second signal strength time between the second access point 452 and the user device 460. The first location of user device 460 may be stored with a first timestamp. The network may then continue to track the location of user device 460 and record (e.g., save) different locations at different times.

FIG. 4B shows an example of user device 460 at a second location at a second time. As shown in FIG. 4B, user device 460 may be located in fitting area 420. Like the discussion above, user device 460 may connect to two or more access points (e.g., second access point 452, third access point 454). Information from the two access points may be used to determine a second location of user device 460. As noted above, the second location may be determined using at least on roundtrip times between the access points and user device 460 or signal strength between the access points and user device 460. Like the first location of user device 460, the second location may be stored with a second timestamp.

Finally, FIG. 4C illustrates an example of user device 460 at a third location at a third time. As shown in FIG. 4C, user device 460 may be located in check-out area 430. The third location may be determined based on user device 460′s connectivity to one or more access points. Similar to the first and second locations discussed above, the third location may be stored with a third timestamp. Each of the locations and the corresponding timestamps may be provided to the machine learning model. Preferably, the locations and corresponding timestamps from a plurality of user devices visit to location 400 may be provided to the machine learning model. Based on the locations and timestamps, the machine learning model may determine one or more attributes and/or information about location 400 from the tracked information of a plurality of user devices. For example, the machine learning model may determine a location of an entrance and the location of the checkout area 440, for example, based on the first place and the last place user devices are detected, respectively. Moreover, the machine learning model may determine a location of fitting area 420. Additionally or alternatively, the machine learning model may determine which user devices are associated with employees of the location, for example, based on detecting the same user device with a predetermined frequency. In further examples, the machine learning model may determine operating hours of location 400, for example, based on the presence of one or more user devices connected to the network. The machine learning model may also determine real-time location of user devices, for example, based on the connectivity information. The real-time location of user devices may be used to predict future locations and/or bottlenecks. In some examples, the machine learning model may provide a notification (e.g., alert) to address potential problems. For example, the machine learning model may determine that a plurality of users will be checking-out shortly. The machine learning model may send one or more recommendations to re-allocate resources to address the plurality of customers that will be checking-out.

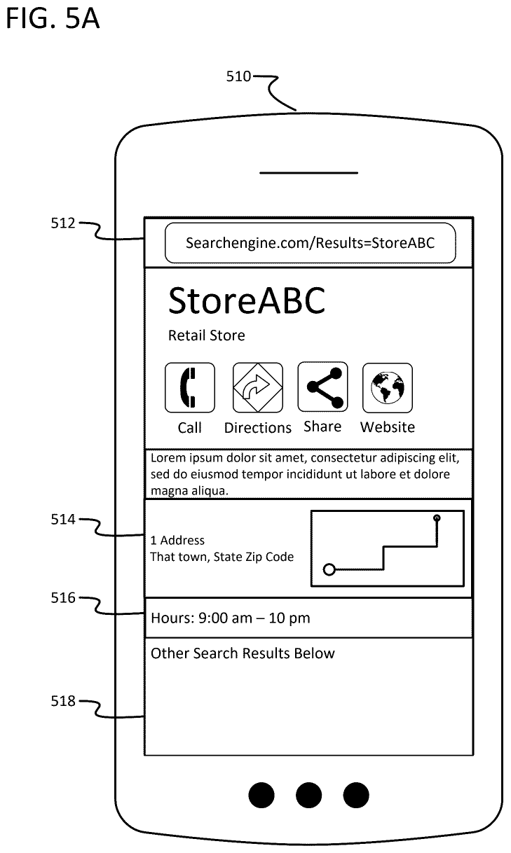

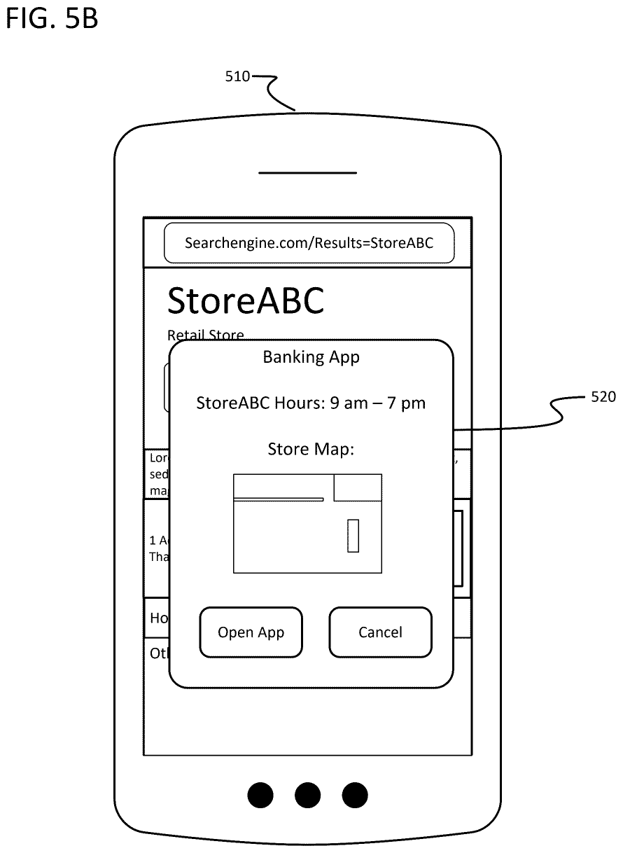

The machine learning model described herein may determine one or more attributes and/or information about a location. FIGS. 5A-5B show an example of displaying information associated with a location according to one or more aspects of the disclosure. FIGS. 5A-5B show an example of a mobile device 510, which may be similar to first user device 110, discussed above with respect to FIG. 1.

As shown in FIG. 5A, mobile device 510 may comprise a first interface 512. First interface 512 may comprise a web browser showing the search results for a particular commercial establishment. As illustrated, first interface 512 may comprise general information about the store, including the store name, the type of store, click-to-call functionality, click-to-direction functionality, an ability to share the information, and/or a link to the store's website. First interface 512 may also include address information 514, operating hours 516, and/or additional search results 518. In FIG. 5A, operating hours 516 indicate that the store is open from 9:00 am to 10:00 pm. One or more applications executing on mobile device 510 may detect the search for the store. In response to detecting the search for the store, the one or more applications may query a database to obtain information related to the store and display information obtained from the database.

FIG. 5B shows an example of displaying the information obtained by the one or more applications. As shown in FIG. 5B, the one or more applications may cause information box 520 to be displayed by mobile device 510. Information box 520 may contain store information retrieved from the database. As shown in FIG. 5B, information box 520 comprises actual operating hours and a map of the store. It will be appreciated that information box 520 may have more or less information. In some instances, information box 520 may comprise a link that opens up another application (e.g., a web browser, a native application, etc.) that provides the information. Most notably, information box 520 comprises the actual operating hours, which are different from the posted operating hours.

Using the techniques described above, the present disclosure uses machine learning models to perform pattern analysis of user devices connecting to a local network. This pattern analysis allows the machine learning models to determine one or more attributes and/or information about a location that would otherwise be unobtainable.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method comprising:
receiving, by a computing device, a first location of a user device connected to a mesh network associated with a commercial establishment, wherein the first location comprises a first timestamp and is determined based on a first distance the user device is from at least a first access point of the mesh network;
receiving a second location of the first user device connected to the mesh network associated with the commercial establishment, wherein the second location comprises a second timestamp and is determined based on a second distance the user device is from at least a second access point that is different from the first access point;
generating, based on pattern analysis using a machine learning algorithm, a mapping of the commercial establishment, wherein the mapping indicates one or more areas of the commercial establishment;
comparing the first timestamp and the second timestamp to publicly available information associated with the commercial establishment;
determining, based on a comparison of the first timestamp and the second timestamp to publicly available operating hours for the commercial establishment, actual operating hours of the commercial establishment; and
providing, based on a request for information associated with the commercial establishment, a response indicating the mapping and the actual operating hours.

2. The method of claim 1, wherein the mesh network comprises a plurality of Internet-of-Things (IoT) devices.

3. The method of claim 2, wherein the plurality of IoT devices comprises at least one of: a point-of-sale terminal, a security device, a security camera, a thermostat, a kiosk, a lighting controller, vending machines, digital signage, monitoring systems, or an employee device.

4. The method of claim 1, wherein the one or more areas of the commercial establishment comprise at least one of a point-of-sale terminal or a fitting room.

5. The method of claim 1, further comprising:
determining, using the machine learning algorithm and based on a determination of one or more locations where a plurality of user devices stall, a point-of-interest.

6. The method of claim 1, further comprising:
determining, using the machine learning model and based on a frequency with which a device connects to the mesh network, a device associated with an employee.

7. The method of claim 6, wherein the determining the actual operating hours is further based on a presence or absence of the device associated with the employee.

8. The method of claim 1, further comprising receiving the publicly available operating hours from the commercial establishment.

9. The method of claim 1, further comprising obtaining, using a scraping algorithm, the publicly available operating hours from a website.

10. The method of claim 1, further comprising:
receiving an identifier associated with the mesh network; and
obtaining, based on the identifier associated with the mesh network, the publicly available operating hours.

11. The method of claim 1, further comprising:
training the machine learning model to identify one or more attributes of a physical location based on location data associated with one or more user devices and publicly available information.

12. A computing device comprising:
one or more processors; and
memory storing instructions that, when executed by the one or more processors, cause the computing device to:
receive a first indication of a first user device connected to a mesh network associated with a commercial establishment, wherein the indication comprises:
a first timestamp; and
a first location of the first user device that is determined based on a first distance the first user device is from at least a first access point of the mesh network;
receive a second indication of a second user device connected to the mesh network associated with the commercial establishment, wherein the second indication comprises:
a second timestamp;
a second location of the second user device that is determined based on a second distance the second user device is from at least the first access point of the mesh network;
generate, based on pattern analysis of at least the first user device and the second user device and using a machine learning algorithm, a mapping of the commercial establishment, wherein the mapping indicates one or more areas of the commercial establishment; and
providing, based on a request for information associated with the commercial establishment, a response indicating the mapping.

13. The computing device of 12, wherein the mapping comprises a real-time location of one or more user devices.

14. The computing device of claim 12, wherein the instructions, when executed by the one or more processors, cause the computing device to identify, using the machine learning model and based on a determination that a third user device has not moved in a predetermined amount of time, a need for assistance.

15. The computing device of claim 14, wherein the instructions, when executed by the one or more processors, cause the computing device to send, to one or more user devices, a notification that a customer is in need of assistance, wherein the notification comprises a location of the third user device.

16. A non-transitory computer-readable medium comprising instructions that, when executed, configure a computing device to:
receive a first indication of a first user device connected to a mesh network associated with a commercial establishment, wherein the first indication comprises a first timestamp;
receive a second indication of a second user device connected to the mesh network associated with the commercial establishment, wherein the second indication comprises a second timestamp;
determine, based on pattern analysis using a machine learning algorithm and based on the first timestamp and based on the second timestamp, a plurality of times during which user devices connect to the mesh network;
compare the plurality of times during which user devices connect to the mesh network to publicly available information associated with the commercial establishment;
determine, based on a comparison of the plurality of times during which user devices connect to the mesh network to the publicly available operating hours for the commercial establishment, actual operating hours of the commercial establishment; and
provide, based on a request for information associated with the commercial establishment, a response indicating the actual operating hours.

17. The non-transitory computer-readable medium of claim 16, wherein the instructions, when executed, configure the computing device to generate, using a second machine learning algorithm, a mapping of the commercial establishment.

18. The non-transitory computer-readable medium of claim 17, wherein the instructions, when executed, configure the computing device to provide, based on a second pattern analysis using the second machine learning algorithm, peak times of the commercial establishment.

19. The non-transitory computer-readable medium of claim 16, wherein the instructions, when executed, configure the computing device to receive operating hours from the commercial establishment.

20. The non-transitory computer-readable medium of claim 16, wherein the instructions, when executed, configure the computing device to obtain, using a scraping algorithm, the publicly available operating hours from a website.
